(19) United States
(12) Patent Application Publication
(10) Pub. No.: US 2012/0237734 A1
(43) Pub. Date: Sep. 20, 2012

(54) PROCESS FOR FORMING A DOUBLE-SIDED SHAPED FOAM ARTICLE

(76) Inventors: Myron J. Maurer, Saginaw, MI (US); Matthew D. Mittag, Midland, MI (US); Alain Michel Andre Sagnard, Drusenheim (FR)

(21) Appl. No.: 13/508,479

(22) PCT Filed: Oct. 26, 2010
(86) PCT No.: PCT/US2010/053995

§ 371 Date: May 7, 2012

Related U.S. Application Data
(60) Provisional application No. 61/263,966, filed on Nov. 24, 2009.

(51) Int. Cl. B29C 43/02; B32B 3/26

(52) U.S. Cl. 428/159; 264/48

(57) ABSTRACT

The invention relates to an improved method of cold forming a double-sided shaped foam article wherein the improvement is using a double-sided foam blank cut from a foam plank having a vertical compressive balance equal to or greater than 0.4 to produce the double-sided shaped foam article. The double-sided foam blank has a first pressing surface and a second pressing surface wherein the difference in compressive strength between the first and second pressing surfaces is equal to or less than 200 percent, most preferably, the compressive strength of the first pressing surface is the same as the compressive strength of the second pressing surface.

### CROSS REFERENCE STATEMENT

This application claims benefit of U.S. Provisional Application No. 61/263,966, filed Nov. 24, 2009, which is incorporated herein by reference.

### FIELD OF THE INVENTION

The invention relates to a double-sided foam blank and method to make wherein the double-sided foam blank is used in a method for forming, preferably cold forming, a shaped foam article which is shaped on two or more sides.

### BACKGROUND OF THE INVENTION

Various methods and techniques are currently known and employed in the industry for shaping articles from a thermoplastic foam material, such as extruded polystyrene (XPS) foams. For example, shapes such as toys and puzzles can be die cut from foams that are formed by extruding a thermoplastic resin containing a blowing agent. There are also examples of foam sheet being shaped into articles such as dishes, cups, egg cartons, trays, and various types of food containers, such as fast food clam shells, take out/take home containers, and the like. More complex shaped foam articles can be made by thermoforming thermoplastic foam sheet. These methods lend themselves to the manufacture of relatively simple shaped articles from typically thin foams which are easily extracted from the molds used to produce them.

Recently, there have been significant advances in shaping more complex, and in particular, thicker thermoplastic foam (i.e., foams greater than 1 mm thick), shaped articles by pressing, or sometimes referred to as cold forming, unique foam compositions and/or structures, for example see USP Publication 2009-0062410. Conventional applications made by cold forming have been disclosed and have been primarily, if not exclusively, one-sided shaped articles. The process to make such one-sided shaped articles requires the use of a foam blank prepared from a foam plank having specific characteristics, such as a density and/or open cell gradient within or through the plank. With the growing success in producing one-sided shaped foam articles, there has been a growing desire for shaped articles that are shaped on at least two sides, for example a raised panel door. Such articles have not previously been disclosed.

While the possibility of two-sided cold forming has been disclosed, there is no suggestion as to how to prepare a suitable foam blank having similar, or preferably the same, foam characteristics on both forming surfaces. It would be desirable to have a double-sided foam blank, and a method to produce thereby, comprising pressing surfaces with similar characteristics so that both sides of the double-sided shaped foam article made therefrom would be similar in appearance and performance. An especially desirable feature would be the capability of producing a double-sided shaped foam article demonstrating similar pressing characteristics and/or dimensional tolerances on both sides.

### SUMMARY OF THE INVENTION

The present invention is a method to manufacture one or more double-sided shaped foam article comprising the steps of:
(i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has a vertical compressive balance equal to or greater than 0.4,
(ii) cutting the foam plank to form a double-sided foam blank having a first pressing surface and a second pressing surface,
(iii) shaping the two pressing surface of the double-sided foam blank into one or more double-sided shaped foam article and surrounding continuous unshaped foam blank by
   (ii)(a) contacting each pressing surface of the double-sided foam blank with a mold, said mold comprises one or a plurality of cavities each cavity having a perimeter defining the shape of the shaped foam article and a cavity surface and
   (ii)(b) pressing the double-sided foam blank with the mold at an applied strain whereby forming one or more double-sided shaped foam article.

In one embodiment of the present invention the difference in compressive strength between the first pressing surface and second pressing surfaces is equal to or less than 200 percent, more preferably equal to or less than 10 percent.

In another embodiment of the present invention the above mentioned foam has a cell gas pressure equal to or less than 1 atmosphere.

Another embodiment of the present invention is the method described hereinabove wherein the thermoplastic polymer is polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyethylene terephthalate; polyvinyl chloride; polyphenylene oxide and polystyrene blend.

Another embodiment of the present invention is the described hereinabove wherein the blowing agent is a chemical blowing agent, an inorganic gas, an organic blowing agent, carbon dioxide, water, or combinations thereof.

Another embodiment of the present invention is the described hereinabove wherein the maximum applied strain is equal to or less than 80 percent.

Another embodiment of the present invention is a double-sided shaped foam article made by the method the described hereinabove, preferably a raised door panel, a garage door panel, packaging material, an insulated window frames, an energy absorbing countermeasure for occupant injury mitigation, a lost core foam molding, a decorative coving, a decorative cornice, an exterior insulation facade panel, an architectural panel, a furniture article, or a foam core insert for various panels.

### BRIEF DESCRIPTION OF THE DRAWINGS

FIG. 1 is an illustration of the step change in the shaped foam article of this invention.

FIG. 2 is a cross-sectional view of a foam plank.

FIG. 3 is a cross-sectional view of a foam plank having been cut twice to provide one or more double-sided foam blank.

FIG. 4 is a cross-sectional view of a foam plank having been cut once to provide one or more double-sided foam blank.

FIG. 5 is a cross-sectional view of a foam plank having been cut three times to provide one or more double-sided foam blank.

FIG. 6 is a cross-sectional view of a forming tool with double sided foam blank in the open position prior to shaping.

FIG. 7 is a cross-sectional view of a forming tool with trimmed and shaped foamed article in the closed position.

FIG. 8 is a cross-sectional view of a forming tool with shaped foam article in the open position after shaping.

FIG. 9a is a photograph of Comparative Example A planed surface.

FIG. 9b is a photograph of Comparative Example A cut surface.

FIG. 10 is a photograph of Example 1.

FIG. 11 is a photograph of Example 2.

FIG. 12 is a photograph of Example 3.

### DETAILED DESCRIPTION OF THE INVENTION

The foamed article of the present invention can be made from any foam composition. A foam composition comprises a continuous matrix material with cells defined therein. Cellular (foam) has the meaning commonly understood in the art in which a polymer has a substantially lowered apparent density comprised of cells that are closed or open. Closed cell means that the gas within that cell is isolated from another cell by the polymer walls forming the cell. Open cell means that the gas in that cell is not so restricted and is able to flow without passing through any polymer cell walls to the atmosphere. The foam article of the present invention can be open or closed celled. A closed cell foam has less than 30 percent, preferably 20 percent or less, more preferably 10 percent or less and still more preferably 5 percent or less and most preferably one percent or less open cell content. Conversely, an open cell foam has 30 percent or more, preferably 50 percent or more, still more preferably 70 percent or more, yet more preferably 90 percent or more open cell content. An open cell foam can have 95 percent or more open cell content. Unless otherwise noted, open cell content is determined according to American Society for Testing and Materials (ASTM) method D6226-05.

Desirably the foam article comprises polymeric foam, which is a foam composition with a polymeric continuous matrix material (polymer matrix material). Any polymeric foam is suitable including extruded polymeric foam, expanded polymeric foam and molded polymeric foam. The polymeric foam can comprise, and desirably comprises as a continuous phase, a thermoplastic or a thermoset polymer matrix material. Desirably, the polymer matrix material has a thermoplastic polymer continuous phase.

A polymeric foam article for use in the present invention can comprise or consist of one or more thermoset polymer, thermoplastic polymer, or combinations or blends thereof. Suitable thermoset polymers include thermoset epoxy foams, phenolic foams, urea-formaldehyde foams, polyurethane foams, polyisocyanurate foams, and the like.

Suitable thermoplastic polymers include any one or any combination of more than one thermoplastic polymer. Olefinic polymers, alkenyl-aromatic homopolymers and copolymers comprising both olefinic and alkenyl aromatic components are suitable. Examples of suitable olefinic polymers include homopolymers and copolymers of ethylene and propylene (e.g., polyethylene, polypropylene, and copolymers of polyethylene and polypropylene). Alkenyl-aromatic polymers such as polystyrene and polyphenylene oxide/polystyrene blends are particularly suitable polymers for of the foam article of the present invention. Other thermoplastic polymers useful for the foam used in the present invention can comprise high impact polystyrene; styrene and acrylonitrile copolymer; acrylonitrile, butadiene, and styrene terpolymer; polycarbonate; polyethylene terephthalate; polyvinyl chloride; and blends thereof.

Desirably, the foam article comprises a polymeric foam having a polymer matrix comprising or consisting of one or more than one alkenyl-aromatic polymer. An alkenyl-aromatic polymer is a polymer containing alkenyl aromatic monomers polymerized into the polymer structure. Alkenyl-aromatic polymer can be homopolymers, copolymers or blends of homopolymers and copolymers. Alkenyl-aromatic copolymers can be random copolymers, alternating copolymers, block copolymers, rubber modified, or any combination thereof and my be linear, branched or a mixture thereof.

Styrenic polymers are particularly desirably alkenyl-aromatic polymers. Styrenic polymers have styrene and/or substituted styrene monomer (e.g., alpha methyl styrene) polymerized in the polymer backbone and include both styrene homopolymer, copolymer and blends thereof. Polystyrene and high impact modified polystyrene are two preferred styrenic polymers.

Examples of styrenic copolymers suitable for the present invention include copolymers of styrene with one or more of the following: acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

Polystyrene (PS) is a preferred styrenic polymer for use in the foam articles of the present invention because of its good balance between cost and property performance.

Styrene-acrylonitrile copolymer (SAN) is a particularly desirable alkenyl-aromatic polymer for use in the foam articles of the present invention because of its ease of manufacture and monomer availability. SAN copolymer can be a block copolymer or a random copolymer, and can be linear or branched. SAN provides a higher water solubility than polystyrene homopolymer, thereby facilitating use of an aqueous blowing agent. SAN also has higher heat distortion temperature than polystyrene homopolymer, which provides a foam having a higher use temperature than a polystyrene homopolymer foam. Desirable embodiments of the present process employ polymer compositions that comprise, even consist of SAN. The one or more alkenyl-aromatic polymer, even the polymer composition itself may comprise or consist of a polymer blend of SAN with another polymer such as polystyrene homopolymer.

Whether the polymer composition contains only SAN, or SAN with other polymers, the acrylonitrile (AN) component of the SAN is desirably present at a concentration of 1 weight percent or more, preferably 5 weight percent or more, more preferably 10 weight percent or more based on the weight of all polymers in the polymer composition. The AN component of the SAN is desirably present at a concentration of 50 weight percent or less, typically 30 weight percent or less based on the weight of all polymers in the polymer composition. When AN is present at a concentration of less than 1 weight percent, the water solubility improvement is minimal over polystyrene unless another hydrophilic component is present. When AN is present at a concentration greater than 50 weight percent, the polymer composition tends to suffer from thermal instability while in a melt phase in an extruder.

The styrenic polymer may be of any useful weight average molecular weight (MW). Illustratively, the molecular weight of a styrenic polymer or styrenic copolymer may be from 10,000 to 1,000,000. The molecular weight of a styrenic polymer is desirably less than about 200,000, which surprisingly aids in forming a shaped foam part retaining excellent surface finish and dimensional control. In ascending further preference, the molecular weight of a styrenic polymer or styrenic copolymer is less than about 190,000, 180,000, 175,000, 170,000, 165,000, 160,000, 155,000, 150,000, 145,000, 140,000, 135,000, 130,000, 125,000, 120,000, 115,000, 110,000, 105,000, 100,000, 95,000, and 90,000. For clarity, molecular weight herein is reported as weight average molecular weight unless explicitly stated otherwise. The molecular weight may be determined by any suitable method such as those known in the art.

Rubber modified homopolymers and copolymers of styrenic polymers are preferred styrenic polymers for use in the foam articles of the present invention, particularly when improved impact is desired. Such polymers include the rubber modified homopolymers and copolymers of styrene or alpha-methylstyrene with a copolymerizable comonomer. Preferred comonomers include acrylonitrile which may be employed alone or in combination with other comonomers particularly methylmethacrylate, methacrylonitrile, fumaronitrile and/or an N-arylmaleimide such as N-phenylmaleimide. Highly preferred copolymers contain from about 70 to about 80 percent styrene monomer and 30 to 20 percent acrylonitrile monomer.

Suitable rubbers include the well known homopolymers and copolymers of conjugated dienes, particularly butadiene, as well as other rubbery polymers such as olefin polymers, particularly copolymers of ethylene, propylene and optionally a nonconjugated diene, or acrylate rubbers, particularly homopolymers and copolymers of alkyl acrylates having from 4 to 6 carbons in the alkyl group. In addition, mixtures of the foregoing rubbery polymers may be employed if desired. Preferred rubbers are homopolymers of butadiene and copolymers thereof in an amount equal to or greater than about 5 weight percent, preferably equal to or greater than about 7 weight percent, more preferably equal to or greater than about 10 weight percent and even more preferably equal to or greater than 12 weight percent based on the total weight or the rubber modified styrenic polymer. Preferred rubbers present in an amount equal to or less than about 30 weight percent, preferably equal to or less than about 25 weight percent, more preferably equal to or less than about 20 weight percent and even more preferably equal to or less than 15 weight percent based on the total weight or the rubber modified styrenic polymer. Such rubber copolymers may be random or block copolymers and in addition may be hydrogenated to remove residual unsaturation.

The rubber modified homopolymers or copolymers are preferably prepared by a graft generating process such as by a bulk or solution polymerization or an emulsion polymerization of the copolymer in the presence of the rubbery polymer. Depending on the desired properties of the foam article, the rubbers' particle size may be large (for example greater than 2 micron) or small (for example less than 2 micron) and may be a monomodal average size or multimodal, i.e., mixtures of different size rubber particle sizes, for instance a mixture of large and small rubber particles. In the rubber grafting process various amounts of an ungrafted matrix of the homopolymer or copolymer are also formed. In the solution or bulk polymerization of a rubber modified (co)polymer of a vinyl aromatic monomer, a matrix (co)polymer is formed. The matrix further contains rubber particles having (co)polymer grafted thereto and occluded therein. High impact poly styrene (HIPS) is a particularly desirable rubber-modified alkenyl-aromatic homopolymer for use in the foam articles of the present invention because of its good blend of cost and performance properties, requiring improved impact strength.

Butadiene, acrylonitrile, and styrene (ABS) terpolymer is a particularly desirable rubber-modified alkenyl-aromatic copolymer for use in the foam articles of the present invention because of its good blend of cost and performance properties, requiring improved impact strength and improved thermal properties.

Foam articles for use in the present invention may be prepared by any conceivable method. Suitable methods for preparing polymeric foam articles include batch processes (such as expanded bead foam steam chest molding processes), semi-batch processes (such as accumulative extrusion processes) and continuous processes such as extrusion foam processes. Desirably, the process is a semi-batch or continuous extrusion process. Most preferably the process comprises an extrusion process, preferably by means of a single or twin screw extruder.

An expanded bead foam process is a batch process that requires the preparation of a foamable polymer composition by incorporating a blowing agent into granules of polymer composition (for example, imbibing granules of a thermoplastic polymer composition with a blowing agent under pressure). Each bead becomes a foamable polymer composition. Often, though not necessarily, the foamable beads undergo at least two expansion steps. An initial expansion occurs by heating the granules above their softening temperature and allowing the blowing agent to expand the beads. A second expansion is often done with multiple beads in a mold and then exposing the beads to steam to further expand them and fuse them together. A bonding agent is commonly coated on the beads before the second expansion to facilitate bonding of the beads together. The resulting expanded bead foam has a characteristic continuous network of polymer skins throughout the foam. The polymer skin network corresponds to the surface of each individual bead and encompasses groups of cells throughout the foam. The network is of higher density than the portion of foam containing groups of cells that the network encompasses.

Complex articles or blocks may be produced by steam chest molding. Blocks may be further shaped by cutting, for example by Computer Numerical Control (CNC) hot wire, to a sheet of uniform thickness. A structural insulated panel (SIP) is an example of a steam chest molded block foam cut to a uniform thickness sheet and adhered to oriented strandboard OSB) or any other suitable facing.

The foamed article can also be made in a reactive foaming process, in which precursor materials react in the presence of a blowing agent to form a cellular polymer. Polymers of this type are most commonly polyurethane and polyepoxides, especially structural polyurethane foams as described, for example, in U.S. Pat. Nos. 5,234,965 and 6,423,755, both hereby incorporated by reference. Typically, anisotropic characteristics are imparted to such foams by constraining the expanding reaction mixture in at least one direction while allowing it to expand freely or nearly freely in at least one orthogonal direction.

An extrusion process prepares a foamable polymer composition of a thermoplastic polymer with a blowing agent in an extruder by heating a thermoplastic polymer composition to soften it, mixing a blowing agent composition together with the softened thermoplastic polymer composition at a mixing temperature and mixing pressure that precludes expansion of the blowing agent to any meaningful extent (preferably, that precludes any blowing agent expansion) and then extruding (expelling) the foamable polymer composition through a die into an environment having a temperature and pressure below the mixing temperature and pressure. Upon expelling the foamable polymer composition into the lower pressure the blowing agent expands the thermoplastic polymer into a thermoplastic polymer foam. Desirably, the foamable polymer composition is cooled after mixing and prior to expelling it through the die. In a continuous process, the foamable polymer composition is expelled at an essentially constant rate into the lower pressure to enable essentially continuous foaming. An extruded foam can be a continuous, seamless structure, such as a sheet or profile, as opposed to a bead foam structure or other composition comprising multiple individual foams that are assembled together in order to maximize structural integrity, thermal insulation and water absorption mitigation capability. An extruded foam sheet may have post-extrusion modifications performed to it as desired, for example edge treatments (e.g., tongue and groove), thickness tolerance control (e.g., via planning or skiving the surface), treatments to the top and/or bottom of the sheet, such as cutting grooves into the surface, laminating a monolithic or composite film and/or fabric, and the like.

Accumulative extrusion is a semi-continuous extrusion process that comprises: 1) mixing a thermoplastic material and a blowing agent composition to form a foamable polymer composition; 2) extruding the foamable polymer composition into a holding zone maintained at a temperature and pressure which does not allow the foamable polymer composition to foam; the holding zone having a die defining an orifice opening into a zone of lower pressure at which the foamable polymer composition foams and an openable gate closing the die orifice; 3) periodically opening the gate while substantially concurrently applying mechanical pressure by means of a movable ram on the foamable polymer composition to eject it from the holding zone through the die orifice into the zone of lower pressure, and 4) allowing the ejected foamable polymer composition to expand to form the foam. U.S. Pat. No. 4,323,528, hereby incorporated by reference, discloses such a process in a context of making polyolefin foams, yet which is readily adaptable to aromatic polymer foams. U.S. Pat. No. 3,268,636 discloses the process when it takes place in an injection molding machine and a thermoplastic with blowing agent is injected into a mold and allowed to foam, this process is sometimes called structural foam molding. Accumulative extrusion and extrusion processes produce foams that are free of such a polymer skin network.

Suitable blowing agents include one or any combination of more than one of the following: inorganic gases such as carbon dioxide, argon, nitrogen, and air; organic blowing agents such as water, aliphatic and cyclic hydrocarbons having from one to nine carbons including methane, ethane, propane, n-butane, isobutane, n-pentane, isopentane, neopentane, cyclobutane, and cyclopentane; fully and partially halogenated alkanes and alkenes having from one to five carbons, preferably that are chlorine-free (e.g., difluoromethane (HFC-32), perfluoromethane, ethyl fluoride (HFC-161), 1,1,-difluoroethane (HFC-152a), 1,1,1-trifluoroethane (HFC-143a), 1,1,2,2-tetrafluoroethane

(HFC-134), 1,1,1,2 tetrafluoroethane (HFC-134a), pentafluoroethane (HFC-125), perfluoroethane, 2,2-difluoropropane (HFC-272fb), 1,1,1-trifluoropropane (HFC-263fb), 1,1,1,2,3,3,3-heptafluoropropane (HFC-227ea), 1,1,1,3,3-pentafluoropropane (HFC-245fa), and 1,1,1,3,3-pentafluorobutane (HFC-365mfc)); fully and partially halogenated polymers and copolymers, desirably fluorinated polymers and copolymers, even more preferably chlorine-free fluorinated polymers and copolymers; aliphatic alcohols having from one to five carbons such as methanol, ethanol, n-propanol, and isopropanol; carbonyl containing compounds such as acetone, 2-butanone, and acetaldehyde; ether containing compounds such as dimethyl ether, diethyl ether, methyl ethyl ether; carboxylate compounds such as methyl formate, methyl acetate, ethyl acetate; carboxylic acid and chemical blowing agents such as azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-dinitrosoterephthalamide, trihydrazino triazine and sodium bicarbonate.

Recent literature reveals that fluorinated olefins (fluoroalkenes) may be an attractive replacement for HFCs in many applications, including blowing agents, because they have a zero Ozone Depletion Potential (ODP), a lower Global Warming Potential (GWP) than HFCs, and high insulating capability (low thermal conductivity). See, for example United States patent application (USPA) 2004/0119047, 2004/0256594, 2007/0010592 and PCT publication WO 2005/108523. These references teach that fluoroalkenes can be suitable for blowing agents and are attractive because they have a GWP below 1000, preferably not greater than 75. USPA 2006/0142173 discloses fluoroalkenes that have a GWP of 150 or less and indicates a preference for a GWP of 50 or less. Particularly desirable fluorinated olefins include those described in WO 2008/118627.

The amount of blowing agent can be determined by one of ordinary skill in the art without undue experimentation for a given thermoplastic to be foamed based on the type of thermoplastic polymer, the type of blowing agent, the shape/configuration of the foam article, and the desired foam density. Generally, the foam article may have a density of from about 16 kilograms per cubic meter (kg/m³) to about 200 kg/m³ or more. The foam density, typically, is selected depending on the particular application. Preferably the foam density is equal to or less than about 160 kg/m³, more preferably equal to or less than about 120 kg/m³, and most preferably equal to or less than about 100 kg/m³.

The cells of the foam article may have an average size (largest dimension) of from about 0.05 to about 5.0 millimeter (mm), especially from about 0.1 to about 3.0 mm, as measured by ASTM D-3576-98. Foam articles having larger average cell sizes, of especially about 1.0 to about 3.0 mm or about 1.0 to about 2.0 mm in the largest dimension, are of particular use when the foam fails to have a compressive ratio of at least 0.4 as described in the following few paragraphs.

In one embodiment of the present invention, to facilitate the shape retention and appearance in the shaped foam article after pressing the shaped foam plank, particularly foams comprising closed cells, it is desirable that the average cell gas pressure is equal to or less than 1.4 atmospheres. In one embodiment, it is desirable that the cell gas pressure is equal to or less than atmospheric pressure to minimize the potential for spring back of the foam after pressing causing less than desirable shape retention. Preferably, the average pressure of the closed cells (i.e., average closed cell gas pressure) is equal to or less than 1 atmosphere (101.3 kilo Pascal (kPa) or 14.7 pounds per square inch (psi)), preferably equal to or less than 0.95 atmosphere, more preferably equal to or less than 0.90 atmosphere, even more preferably equal to or less than 0.85 atmosphere, and most preferably equal to or less than 0.80 atmosphere.

Cell gas pressures may be determined from standard cell pressure versus aging curves. Alternatively, cell gas pressure can be determined according to ASTM D7132-05 if the initial time the foam is made is known. If the initial time the foam is made is unknown, then the following alternative empirical method can used: The average internal gas pressure of the closed cells from three samples is determined on cubes of foam measuring approximately 50 mm. One cube is placed in a furnace set to 85° C. under vacuum of at least 1 Torr or less, a second cube is placed in a furnace set to 85° C. at 0.5 atm, and the third cube is placed in the furnace at 85° C. at atmospheric pressure. After 12 hours, each sample is allowed to cool to room temperature in the furnace without changing the pressure in the furnace. After the cube is cool, it is removed from the furnace and the maximum dimensional change in each orthogonal direction is determined. The maximum linear dimensional change is then determined from the measurements and plotted against the pressure and curve fit with a straight line using linear regression analysis with average internal cell pressure being the pressure where the fitted line has zero dimensional change.

The compressive strength of the foam article is established when the compressive strength of the foam is evaluated in three orthogonal directions, E, V and H, where E is the direction of extrusion, V is the direction of vertical expansion after it exits the extrusion die and H is the direction of horizontal expansion of the foam after it exits the extrusion die. These measured compressive strengths, C_{E}, C_{V} and C_{H}, respectively, are related to the sum of these compressive strengths, C_{T}, such that at least one of C_{E}/C_{T}, C_{V}/C_{T} and C_{H}/C_{T}, has a value of at least 0.40, preferably a value of at least 0.45 and most preferably a value of at least 0.50. When using such a foam, the pressing direction is desirably parallel to the maximum value in the foam.

The polymer used to make the foam article of the present invention may contain additives, typically dispersed within the continuous matrix material. Common additives include any one or combination of more than one of the following: infrared attenuating agents (for example, carbon black, graphite, metal flake, titanium dioxide); clays such as natural absorbent clays (for example, kaolinite and montmorillonite) and synthetic clays; nucleating agents (for example, talc and magnesium silicate); fillers such as glass or polymeric fibers or glass or polymeric beads; flame retardants (for example, brominated flame retardants such as brominated polymers, hexabromocyclododecane, phosphorous flame retardants such as triphenylphosphate, and flame retardant packages that may including synergists such as, or example, dicumyl and polycumyl); lubricants (for example, calcium stearate and barium stearate); acid scavengers (for example, magnesium oxide and tetrasodium pyrophosphate); UV light stabilizers; thermal stabilizers; and colorants such as dyes and/or pigments.

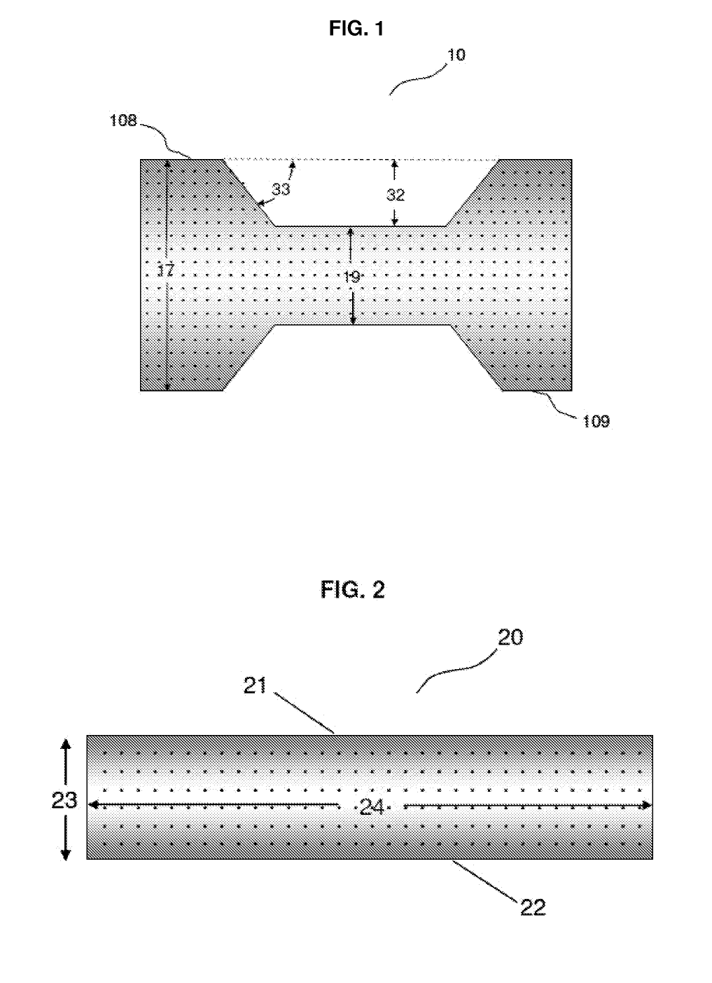

The process of the present invention provides a shaped foam article. As defined herein, shaped means the foamed article typically has one or more contour that creates a step change (impression) in height 32 of at least 1 millimeter or more in the shaped foam article 10 having a maximum thickness 17 as shown in FIG. 1. A shaped foam article has at least one surface that is not planar.

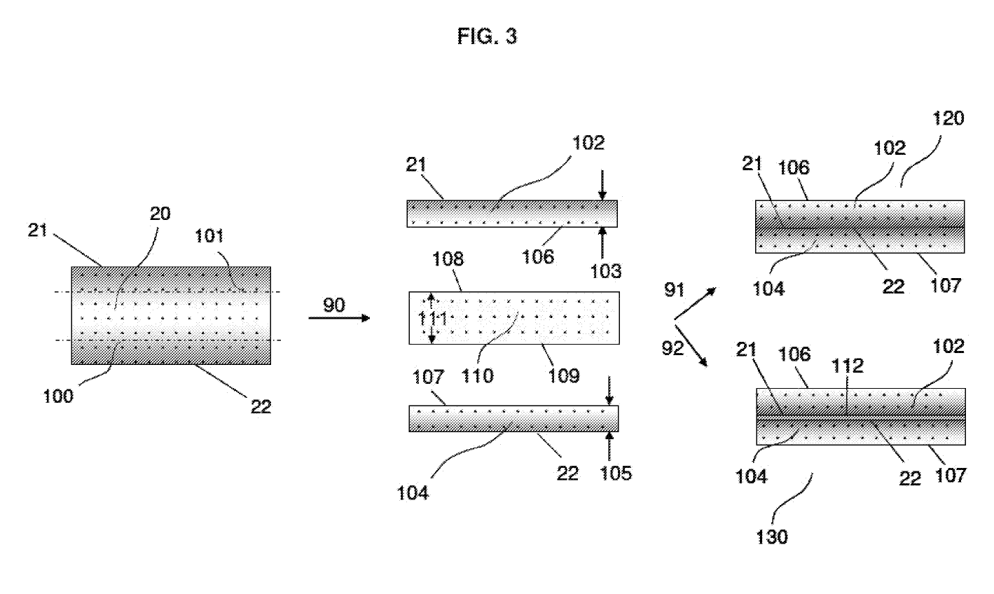

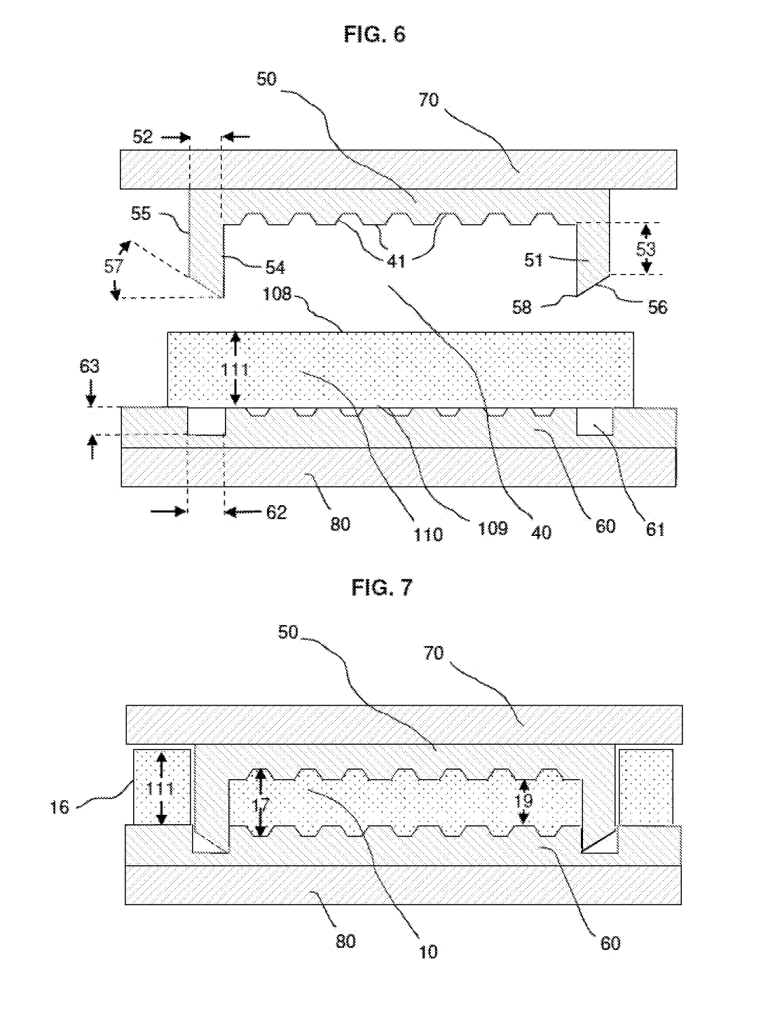

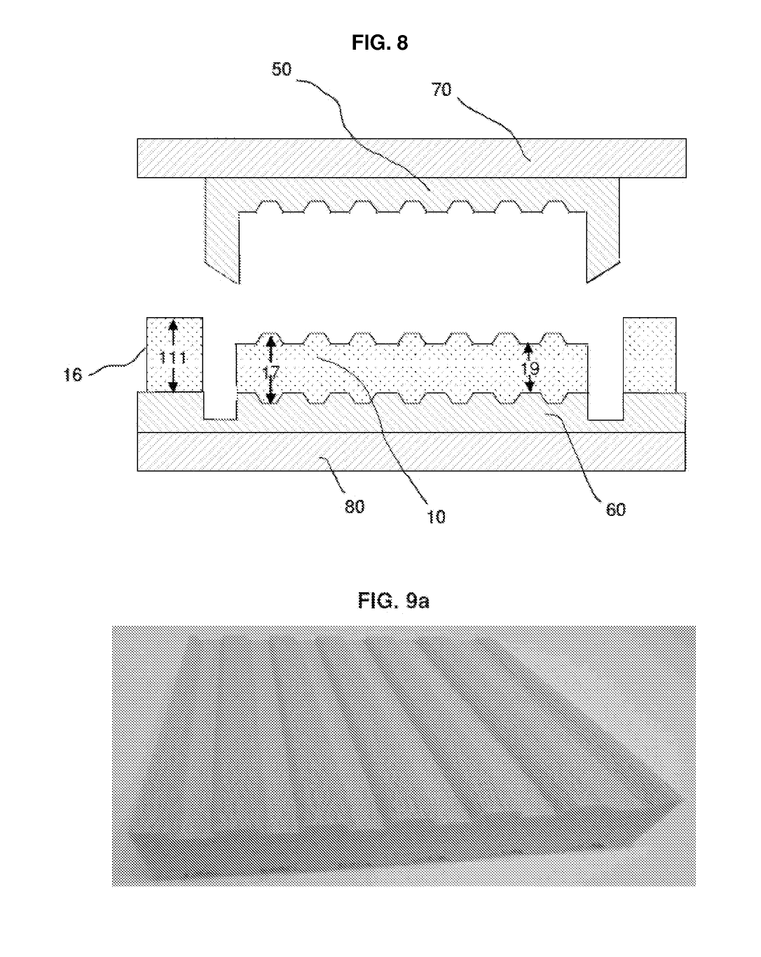

A most preferred foam article is a double-sided shaped foam article 10 (FIG. 1) which may be prepared from a foamed polymer as described herein above in the form of a double-sided foam blank 110 (FIG. 3) cut from a foam plank 20 (FIG. 2) and further shaped (FIGS. 6 to 8) to give a double-sided shaped foam article 10. The use of the term plank, herein, is merely used for convenience with the understanding that configurations other than a flat board having a rectangular cross-section may be extruded and/or foamed (e.g., an extruded sheet, an extruded profile, a pour-in-place bun, etc.). A particularly useful method to shape foam articles is to start from a double-sided foam blank 110 cut from a foam plank 20 which has been extruded from a thermoplastic comprising a blowing agent. As per convention, but not limited by, the extrusion of the plank is taken to be horizontally extruded (the direction of extrusion is orthogonal to the direction of gravity). Using such convention, the plank's top surface 21 is that farthest from the ground and the plank's bottom surface 22 is that closest to the ground, with the height of the foam (thickness) 23 being orthogonal to the ground when being extruded. Suitable equipment useful for cutting the foam plank and/or blank and preparing a pressing surface are band saws, computer numeric controlled (CNC) abrasive wire cutting machines, CNC hot wire cutting equipment, foam “skiving” equipment to split the foam via use of a wedge block that effectively splits the foam with a stationary wedge and moving plank, and the like.

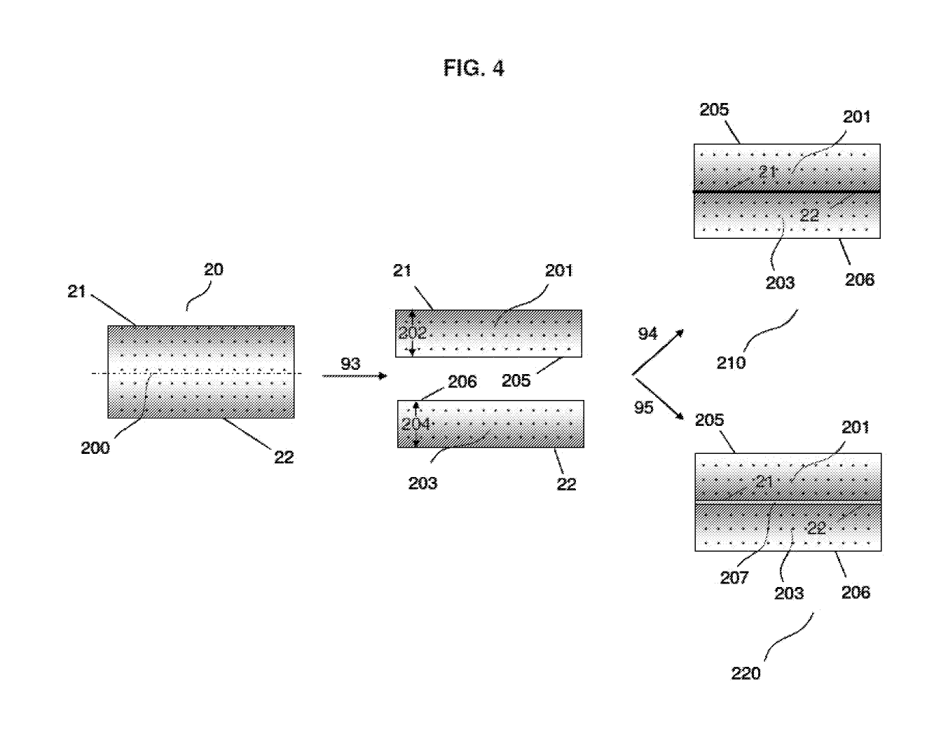

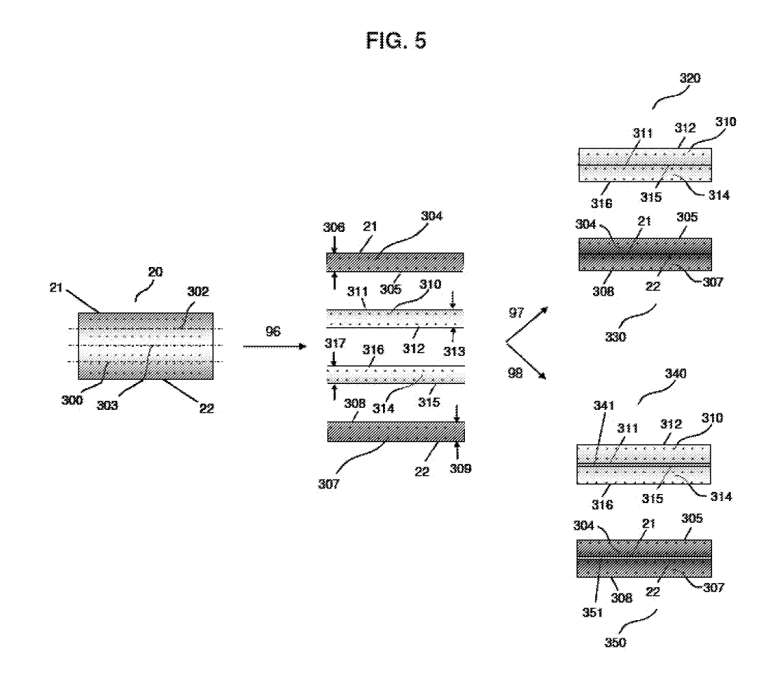

The double-sided shaped foam article of the present invention is pressed from a double-sided blank, for example 110. A double-sided blank 110 is cut from a foam plank 20, for example see FIG. 3 wherein cuts 100 and 101 result in the foam plank being cut into three pieces 102, 110, and 104. The resulting foam structure cut from a foam plank is referred to as a ‘foam blank’ and if the blank has two cut surfaces, it is referred to as a double-sided foam blank, for example double-sided foam blanks 110, 120, 130, 210, 220, 320, 330, 340, and 350. The foam blank is removed from and/or separated from the foam plank prior to shaping. One or more cuts may be necessary to prepare one or more double-sided foam blank from a foam plank, see FIG. 4 for one cut, FIG. 3 for two cuts, and FIG. 5 for three cuts. A first cut surface of the double-sided foam blank becomes the first pressing surface 108 and a second cut surface of the double-sided foam blank becomes the second pressing surface 109. Multiple cuts (e.g., 2, 3, 4, 5, or more) and multiple (e.g., 2, 3, 4, 5, or more) foam blanks and/or double-sided foam blanks may be cut and or assembled from a single foam plank.

The improvement in the process of the present invention is the use of a ‘double-sided foam blank’. The term ‘double-sided foam blank’ is used to describe a foam blank having two pressing surfaces 108 and 109 which are cut from a foam plank having a top 21 and bottom surface 22 wherein neither of the pressing surfaces of the double-sided foam blank are the plank's top surface 21 or bottom surface 22.

The forming of the shaped foam articles is surprisingly enhanced by using a double-sided foam blank 110 cut from a foam plank 20 that has at least one direction where at least one of C_{E}/C_{T}, C_{V}/C_{T} and C_{H}/C_{T} is at least 0.4 said one of C_{E}/C_{T}, C_{V}/C_{T} and C_{H}/C_{T} (compressive balance), C_{E}, C_{V} and C_{H} being the compressive strength of the cellular polymer in each of three orthogonal directions E, V and H where one of these directions is the direction of maximum compressive strength in the foam and C_{T} equals the sum of C_{E}, C_{V} and C_{H}.

In one embodiment, the foam compressive strengths at the pressing (outer) surfaces 108 and 109 of the double-sided foam blank 110 are similar and are individually greater than the foam compressive strength at the core of the foam blank.

In a preferred embodiment, the foam compressive strengths at the pressing (outer) surfaces 106 and 107 of the double-sided foam blank 120 are similar and are individually less than the foam compressive strength at the core of the foam blank. In one embodiment of the present invention, the compressive strength of the first pressing surface CS₁ₛₜ of the double-sided foam blank is different than the compressive strength of the second pressing surface CS_{2nd} of the double-sided foam blank: CS₁ₛₜ CS_{2nd}. If the compressive strength of the first and second pressing surfaces are different, the difference in percent is calculated by:

% difference=[(CS₁ₛₜ−CS_{2nd})/CS₁ₛₜ]×100

wherein CS₁ₛₜ is the larger compressive strength value.

Preferably, the difference in compressive strength between the first and second pressing surfaces is equal to or less than 60 percent, more preferably equal to or less than 55 percent, more preferably equal to or less than 50 percent, more preferably equal to or less than 45 percent, more preferably equal to or less than 40 percent, more preferably equal to or less than 35 percent, more preferably equal to or less than 30 percent, more preferably equal to or less than 25 percent, more preferably equal to or less than 20 percent, more preferably equal to or less than 15 percent, more preferably equal to or less than 12.5 percent, more preferably equal to or less than 10 percent, more preferably equal to or less than 7.5 percent, more preferably equal to or less than 5 percent, more preferably equal to or less than 2.5 percent, more preferably equal to or less than 1 percent, more preferably equal to or less than 0.5 percent, more preferably equal to or less than 0.25 percent, more preferably equal to or less than 0.1 percent, more preferably equal to or less than 0.05 percent, and most preferably the difference in compressive strength between the first and second pressing surfaces is equal to or less than 0.01 percent.

In a preferred embodiment of the present invention, the foam compressive strength at the first pressing surface CS₁ₛₜ of the double-sided foam blank is equal to the foam compressive strength at the second pressing surface CS_{2nd} of the double-sided foam blank:

CS₁ₛₜ=CS_{2nd}.

Any suitable method to prepare a double-sided foam blank from a foam plank is acceptable. The following examples are illustrative, but not inclusive of all possible ways to make a double-sided foam blank. In one embodiment a foam plank is cut with a single cut 200 forming two foam blanks 201 and 203, see FIG. 4. Foam blank 201 has uncut surface 21 and cut surface 205. Foam blank 203 has uncut surface 22 and cut surface 206. The thickness of each blank may be different 202 204 or preferably equal to each other, 202=204. In one embodiment, a double-sided foam blank is formed from foam blanks 201 and 203 by positioning them back to back with surfaces 21 adjacent to 22 so that the first 205 and second 206 cut surfaces become the pressing surfaces of the double-sided foam blank 210. In a second embodiment, foam blanks 201 and 203 are positioned back to back as described hereinabove but further comprise a bonding layer 207 disposed between both foam blanks 201 and 203 and adjacent to and adhering to uncut surfaces 21 and 22 to form a double-sided foam blank 220. The bonding layer 207 may be any means known in the art which will bond two foams within the scope of the present invention. For example, the bonding layer 112 may be an adhesive, such as a one or two component polyurethane adhesive, an epoxy adhesive, a reactive hot melt adhesive, a thermoplastic hot melt adhesive, an acrylic adhesive; a double sided tape; sonic welding, heat welding, solvent welding, or the like. In one embodiment, the adhesive agent includes a solvent which preferably does not dissolve the foam of the foam blank. It may be preferable to use a copolymer as the adhesive agent of which the softening point is lower than that of the foam being bonded, for example for bonding blanks made of a styrenic foam, the copolymer of vinyl acetate and ethylene, or a mixture of vinyl acetate polymer and ethylene polymer. In both cases, a vinyl acetate content of from 5 to 50 weight percent and an ethylene content of 95 to 50 weight percent is preferred. This copolymer or polymer mixture is formed as a film which is heated and melted and to each side of the film is pressed the non-pressing surface of each of the foam blanks being bonded, thus sandwiched between the two foam blanks.

The adhesive may be applied to all or part of the non-pressing surfaces of the foam blanks being joined. In other words, the adhesive may be applied to the entire surfaces or applied to scattered local areas.

In another embodiment a foam plank is cut twice 100 and 101 forming three foam blanks 102, 104, and 110, see FIG. 3. The three blanks can be used alone 110 or combined 102+104 to provide double-sided foam blanks. In one embodiment, a double-sided foam blank 110 is a single foam blank with two pressing surfaces 108 and 109, each surface prepared by a separate cut 100 and 101. In another embodiment, the double-sided foam blank may be made of two foam blanks 102 and 104 prepared from twice cutting 100 and 101 a foam plank. One resulting foam blank 102 having cut surface 106 and uncut surface 21. Another resulting foam blank 104 having cut surface 107 and uncut surface 22. Foam blanks 102 and 104 are positioned back to back with surfaces 21 adjacent to 22 so that the first 106 and second 107 cut surfaces become the pressing surfaces of the double-sided foam blank 120. In yet another embodiment, two foam blanks 102 and 104 are positioned back to back as described hereinabove but further comprise a bonding layer 112 as described hereinabove in contact with and adhering the two uncut surfaces 21 and 22 together to form a double-sided foam blank 130.

In another embodiment a foam plank is cut three times 300, 302, and 303 forming four foam blanks 304, 307, 310, and 314, see FIG. 5. Two of the four blanks may be used alone 310 and 314 to provide a double-sided foam blank and/or two blanks may be combined 310+314, 304+307 to provide different double-sided foam blanks.

In one embodiment, a double-sided foam blank 310 is a single foam blank with two pressing surfaces 311 and 312, each surface prepared by separate cuts 302 and 303. In another embodiment, a different double-sided foam blank 314 is a single foam blank with two pressing surfaces 315 and 316, each surface prepared by separate cuts 300 and 303.

In yet another embodiment, a double-sided foam blank may be made by combining two foam blanks 310 and 314 back to back with cut surfaces 311 adjacent to cut surface 315 so that the first 312 and second 316 cut surfaces become the pressing surfaces of the double-sided foam blank 320.

In another embodiment, foam blanks 310 and 314 are positioned back to back as described hereinabove but further comprise a bonding layer 341 as described hereinabove deposed between and in contact with and adhering to both cut surfaces 311 and 315 together to form a double-sided foam blank 340.

In yet another embodiment, a double-sided foam blank may be made of two foam blanks 304 and 307 that are positioned back to back with uncut surfaces 21 adjacent to uncut surface 22 so that the first 305 and second 308 cut surfaces become the pressing surfaces of the double-sided foam blank 330.

In another embodiment, foam blanks 304 and 307 are positioned back to back as described hereinabove but further comprise a bonding layer 351 as described hereinabove deposed between and in contact with and adhering to both uncut surfaces 21 and 22 to form a double-sided foam blank 350.

In further embodiments (not shown in the FIGS.), different combinations of foam blanks may be combined to provide a double-sided foam blank, for instance, blanks 307 and 314 may be combined with cut surface 316 adjacent to uncut surface 22, with or without an adhesive layer; or blanks 307 and 310 may be combined with cut surface 312 adjacent to uncut surface 22, with or without an adhesive layer; or blanks 304 and 310 may be combined with cut surface 312 adjacent to uncut surface 21, with or without an adhesive layer; or blanks 304 and 314 may be combined with cut surface 316 adjacent to uncut surface 21, or the like.

The process to make and resulting double-sided foam blank as described hereinabove are illustrative, but not inclusive, of ways to provide double-sided foam blanks from a foam plank that has been cut one or more times.

In one embodiment, a double-sided foam blank has a density gradient from the pressing surfaces to the core of the double-sided foam blank. In a particular embodiment, a double-sided foam blank (for example 110) having a first and second pressing surface 108 and 109, respectively, has a density gradient from the pressing surfaces 108 and 109 to the core of the double-sided foam blank 110. Generally, it is desirable to have a density gradient of at least 1 percent, 2 percent, 5 percent, 7.5 percent, 10 percent, 12.5 percent, 15 percent, 20 percent, 25 percent or even 30 percent from the pressing surfaces to the core of the double-sided foam blank. To illustrate the density gradient, if the density of the foam at the pressing surfaces (i.e., within a millimeter or two of the surface) is 3.0 pounds per cubic foot (pcf), the density would be for a 10 percent gradient either 2.7 or 3.3 pcf at the core of the double-sided foam blank. Preferably, the local density at the pressing surfaces is lower than the local density at the core of the double-sided foam blank. Thus, when the pressing surfaces have a density of 2.7 pcf, it is desired for the pressing surface to be 3 pcf.

In one embodiment of the present invention, the shaped foam article 10 may be formed from a double-sided foam blank 110 and in a subsequent and separate step, the shaped foam article is separated, or trimmed from the continuous unshaped foam blank 16. In another embodiment, the double-sided foam blank 110 may be cut to fit into a forming tool prior to contact with the tool. In another embodiment, the final shape maybe cut from the pressed plank, for example, the foam double-sided foam blank 110 may be pressed to form a shape into the pressing surface and the shaped foam article subsequently cut from the pressed foam double-sided foam blank. When cutting the foam, any suitable method may be used, such as those known in the art and those described previously for cutting the foam to form the pressing surfaces. In yet another, preferred embodiment, the shaped foam article is trimmed from the continuous unshaped double-sided foam blank by a trimming rib 51 simultaneously as the shaped foam article is formed. In addition, methods that involve heat may also be used to cut the foam since the pressed shape has already been formed in the pressing surface.

The method of the present invention may use a molding machine, sometimes referred to as a press, to form the shaped foam article of the present invention. This process is often referred to as discontinuous as it consists of a cycle where a double-sided foam blank is placed in an open mold, the mold closes to form an article, then after the article is formed the mold opens. The shaped foam article is removed from the mold, a new double-sided foam blank is inserted into the mold and the process repeated.

Typically, a press has a stationary platen and a movable platen to which a forming tool may be affixed. The pressing surfaces of the double-sided foam blank are contacted with a forming tool such as a die face or mold. Herein die face and/or mold means any tool having an impressed shape and/or cavity that when pressed into the double-sided foam blank will cause the foam to take the shape of the die face. That is, the material making up the forming tool is such that it does not deform when pressed against the double-sided foam blank, but the double-sided foam blank deforms to form and retain the desired shape of the forming tool, die face, and/or mold cavity. Depending on the shape of the shaped article being formed, the mold may comprise one or more cavity portion, one or more core portion, and/or a cavity half and a core half. If present, a cavity half of the mold may be affixed to the stationary platen, but more often is affixed to the movable platen. Hereinafter, when the mold half with a cavity is affixed to the movable platen is referred to as the movable forming surface and the stationary platen is referred to as the stationary forming surface. The stationary platen may or may not have a mold half with another cavity portion or core portion affixed to it.

Both sides of the double-sided foam blank are shaped. They may be shaped the same or they may be shaped differently, in other words, the pattern impressed into the two sides may be the same or different. In a preferred embodiment, both the mold half with the cavity and the mold half with the core impart shape to the shaped foam article.

Typically when pressing, at least a portion of the foam is pressed such that the foam is compressed to a thickness of 95 percent or less of the to-be-pressed foam thickness 17 as shown in FIG. 1, which typically corresponds to just exceeding the yield stress of the foam (elastically deforming the foam) Likewise, when pressing the part, the maximum deformation of the foam (elastically deforming the foam) is typically no more than about 20 percent of the original thickness 111 of the double-sided foam blank 110 ready to be pressed. In other words, the final thickness of the pressed foam (shaped foam article) is equal to or less than 80 percent of the original thickness of the double-sided foam blank.

The forming tool, because a shape is most often desired, typically has contours that create an impression (step change) in height 32 of at least a millimeter in the shaped foam article 10 having thickness 17 as shown in FIG. 1. The height/depth 32 of an impression may be measured using any suitable technique such as contact measurement techniques (e.g., coordinate measuring machines, dial gauges, contour templates) and non-contact techniques such as optical methods including laser methods. The height of the step change 32 may be greater than 1 millimeter such as 1.5, 2, 2.5, 3, 3.5, 4, 5, 6, 7, 8, 9 and 10 to a height that is to a point where there are no more foam cells to collapse such that pressing further starts to elastically deform the plastic (polymer) of the foam.

The step change, surprisingly, may be formed where the foam undergoes shear. For example, the foam may have a shear or draft angle 33 (θ) of about 45° to about 90° from the press surface 108 of the shaped foam article 10 in a step change of height 33. It is understood that the shear angle θ may not be linear, but may have some curvature, with the angle in these cases being an average over the curvature. The angle surprisingly may be greater than 60°, 75° or even by 90° while still maintaining an excellent finish and appearance. The draft angle at any point along the mold surface is defined as the tangent of the angle taken at that location of the mold.

In another aspect of the invention, a foam having a higher concentration of open cells at the pressing surfaces of the foam than the concentration of open cells within the core of the foam is contacted and pressed to form the shape. In this aspect of the invention the foam may be any foam, preferably a styrenic foam such as the extruded styrenic polymer foam described above. It may also be any other styrenic polymeric foam such as those known in the art including, for example, where the blowing agent is added to polymer beads, typically under pressure, as described by U.S. Pat. No. 4,485,193 and each of the U.S. patents cited hereinabove.

With respect to this open cell gradient, the gradient is as described above for the density gradient where the concentration of open cells if determined microscopically and is the number of open cells per total cells at the surface.

Generally, the amounts of open cells in this aspect of the invention at the pressing surfaces are independently at least 5 percent to completely open cell. Desirably, the open cells at the pressing surfaces are independently at least in ascending order of 6 percent, 7 percent, 8 percent, 10 percent, 20 percent, 30 percent, 40 percent, 50 percent, 60 percent, 70 percent, 80 percent, 90 percent and completely open cell at the pressing surface.

The foam may have the open cells formed at the pressing surfaces by mechanical means such as those described above (e.g., planing/machining or cutting) or may be induced chemically, for example, by use of suitable surfactants to burst closed cells at the surface.

In one embodiment of the present invention, neither the forming tool, e.g., the die face and/or mold nor the “bulk” foam (i.e., greater than 50 percent) are heated (i.e., the foam is shaped at ambient temperature, which is defined herein to be 15-30° C.).

In one embodiment of the present invention, one or both sides of the forming tool, e.g., both sides of the die face and/or mold are heated, but the “bulk” foam (i.e., greater than 50 percent) is not (ambient 15-30° C.) and the foam is pressed. Surprisingly, heating the die faces with the foams having open cells at the surface results in superior surface contour and appearance as compared to doing the same with a foam without such open cells at the surface, in this case, the appearance of the foam is degraded.

In another embodiment of the present invention, the shaped foam article may be perforated. Such an article may have a plurality of perforations. Perforation is defined herein to mean one or more hole which passes through the double-sided foam blank/shaped article one surface to another, i.e., from the top surface to the bottom surface. Perforation may occur at any time, in other words, it may be done to the double-sided foam blank prior to shaping, to the shaped foam article, or a combination of the two. The perforations extend through the shaped foam article, for instance for a shaped foam article made from a double-sided foam blank, through the depth of the double-sided foam blank. The foam may be perforated by any acceptable means. Perforating the foam article may comprise puncturing the foam article with a one or more of pointed, sharp objects in the nature of a needle, pin, spike, nail, or the like. However, perforating may be accomplished by other means than sharp, pointed objects such as drilling, laser cutting, high-pressure fluid cutting, air guns, projectiles, or the like. The perforations may be made in like manner as disclosed in U.S. Pat. No. 5,424,016, which is hereby incorporated by reference.

When pressing with a heated forming tool, the contact time with the foam is typically from about 0.1 second to about 60 seconds. Preferably, the dwell time is at least about 1 second to at most about 45 seconds. Dwell time is defined as the duration at which the forming tool remains stationary with the foam subjected to maximum applied strain.

When pressing with a heated forming tool, the temperature of the forming tool is not so hot or held for too long a time such that the foam is degraded. Typically, the temperature of the forming tool is about 50° C. to about 200° C. Preferably, the temperature is at least about 60°, more preferably at least about 70° C., even more preferably at least about 80° C. and most preferably at least about 90° C. to preferably at most about 190°, more preferably at most about 180° , even more preferably at most about 170° C. and most preferably at most about 160° C.

The forming tool provides the shape to the shaped foam article. The forming tool comprises the forming cavity and/or core (i.e, the shape) and all the necessary equipment for temperature control, trimming, ejection, etc. The most frequent case, the forming tool, such as a mold, comprises two halves 50 and 60, one which may be the stationary platen 80 or which is mounted to a stationary platen (sometimes referred to as the core side or stationary forming surface), the other mold half 50 to a moveable platen 70 (sometimes referred to as the cavity side or movable forming surface) and moving with it. The shape of the article will dictate the design and complexity of the forming tool. In one embodiment, the mold half with a cavity is affixed to the movable platen and a mold have with a second cavity or core is affixed to the stationary platen FIG. 6 to FIG. 8. Conventional materials of construction are used for the mold such as, but not limited to: aluminum, composites (i.e. epoxy), wood, metal, porous tooling such as METAPOR™, and the like.

A movable platen 70 comprising a first mold half 50 can move toward or away from the stationary platen 80 comprising a second mold half 60, the mold halves may comprise a single cavity mold or optionally a multiple cavity mold. In between the mold halves is placed the double-sided foam blank 110. To shape the foam, the movable platen 70 moves towards the stationary platen such that the first pressing surface 108 of the double-sided foam blank 110 is contacted by the first mold half 50 and as the movable platen moves towards the stationary platen the second pressing surface 109 of the double-sided foam blank is pressed against the second mold half 60 affixed to the stationary platen 70. For a multi-cavity mold, each cavity may be identical in shape or there may be as many different shapes as cavities or there may be a combination of multiple cavities with the same first shape in combination with multiple cavities with one or more shapes different than the first shape. The layout of cavities in a multi-cavity mold may be side by side, in tandem, or any other desirable configuration. A multi-cavity mold produces more than one shaped article in a plank per molding cycle.

In one embodiment of the present invention shaping and trimming may be separate steps. In another embodiment of the present invention the shaping/trimming step occur in the same step of the present invention.

The present invention can be used to make double-sided shaped foamed articles such as, but not limited to: raised door panels, garage door panels, packaging materials, insulated window frames, energy absorbing countermeasures for occupant injury mitigation, lost core foam moldings, decorative covings or cornices, exterior insulation facade panels, architectural panels, furniture articles, foam core inserts for various panels, and the like.

### Test Methods

The density profile through the thickness of each foam blank was tested using a QMS Density Profiler, model QDP-01X, from Quintek Measurement Systems, Inc. Knoxville, Tenn. The High Voltage kV Control was set to 90 percent, the High Voltage Current Control was set to 23 percent and the Detector Voltage was approximately 8 v. Data points were collected every 0.06 mm throughout the thickness of the foam. Approximate thickness of the foam samples in the plane of the x-ray path was 2 inches. Mass absorption coefficients were calculated for each sample individually, based on the measured linear density of the foam part being tested. The skin density, ρₛₖᵢₙ, was reported as a maximum value whereas the core density, ρ_{core}, was averaged within an approximate 5 mm range. The density gradient, in units of percentage, was then computed in accordance with the following equation:

$$Density Gradient ( percent ) = 100 \cdot \frac{( {ρ}_{core} - {ρ}_{skin} )}{{ρ}_{skin}}$$

The compressive response of each material was measured using a Materials Test System equipped with a 5.0 displacement card and a 4,000 lbf load card. Cubical samples measuring the approximate thickness of each plank were compressed at a compressive strain rate of 0.065 s⁻¹. Thus, the crosshead velocity of the MTS, in units of inches per minute, was programmed in accordance with the following equation:

Crosshead Velocity=Strain Rate*Thickness*60

where the thickness of the foam specimen is measured in units of inches. The compressive strength of each foam specimen is calculated in accordance with ASTM D1621 while the total compressive strength, C_{ST}, is computed as follows:

C_{ST}=C_{SV}+C_{SE}+C_{SH}

where C_{SV}, C_{SE} and C_{SH} correspond to the compressive strength in the vertical, extrusion and horizontal direction respectively. Thus, the compressive balance, R, in each direction can be computed as shown below:

R_{V}=C_{SV}/C_{ST}

R_{E}=C_{SE}/C_{ST}

R_{H}=C_{SH}/C_{ST}

Open cell content was measured by using an Archimedes method on 25 mm×25 mm×50 mm samples.

While certain embodiments of the present invention are described in the following example, it will be apparent that considerable variations and modifications of these specific embodiments can be made without departing from the scope of the present invention as defined by a proper interpretation of the following claims.

Percent crack reduction Cᵣ can be determined from the ratio of the rough crack value R_{cv} to the smooth crack value S_{cv} by the following formula:

Cᵣ=(1−R_{cv}/S_{cv})*100

wherein crack values are manually calculated for a shaped foam article pressed by a mold with a smooth cavity surface S_{cv} by first measuring the length of each crack in the shaped foam article (or a specified portion thereof) made from a mold with a smooth cavity surface and then adding each of the individual crack lengths together to get an overall smooth crack value S_{cv} in units of length. Crack values are manually calculated for a shaped foam article pressed by a mold with a reduced-slip cavity surface R_{cv} by first measuring the length of each crack, if any, in the shaped foam article (or the same specified portion as used in the shaped foam article pressed from the mold with a smooth cavity surface) made from a mold with a reduced-slip cavity surface and then adding each of the individual crack lengths together to get an overall reduced-slip crack value R_{cv} in units of length.

Induced strain is a function of the initial thickness of the foam blank and the final part thickness and is calculated as follows:

$$Induced Strain ( \% ) = 100 \cdot \frac{( {t}_{o} - {t}_{f} )}{{t}_{o}}$$

wherein tₒ is original thickness of the foam blank and t_{f} is the final thickness of the pressed shaped foam article, both measurements are measured and recorded using a digital linear gage.

Applied strain is a function of the initial thickness of the foam blank and the degree of tool compression and is calculated as follows:

$$Applied Strain ( \% ) = 100 \cdot \frac{( {t}_{o} - {d}_{t} )}{{t}_{o}}$$

wherein tₒ is original thickness of the foam blank and dₜ is the distance the tool is pressed into the foam blank.

### EXAMPLES

For Comparative Example A and Examples 1 to 3 an IMPAXX™ 300 Foam Plank, available from The Dow Chemical Company, Midland, Mich. is used. The IMPAXX 300 Foam Plank is an extruded polystyrene foam with dimensions measuring 2,200 mm by 600 mm by 110 mm in the length, width and thickness directions respectively. The IMPAXX 300 Foam Plank has a density gradient of about −18.6 percent, an open cell content of about 4.9, a cell gas pressure of about 0.6 atmosphere (atm), and a vertical compressive balance Rᵥ of 0.59. About 7 millimeters (mm) layer is removed by planing from the top and the bottom of an IMPAXX 300 Foam Plank. The planed IMPAXX 300 Foam Plank is then cut using a Baumer abrasive wire saw to render foam blanks for shaping. Comparative Example A is prepared by cutting the foam plank once to provide a foam blank having a planed surface (top or bottom) opposite a cut surface (core) measuring approximately 355 mm by 241 mm by 50 mm, in the length, width and thickness directions respectively. The compressive strength for the planed surface is about 64 psi and 34 psi for the cut surface. Example 1 is prepared by cutting a foam plank twice (see FIG. 3) to provide a double-sided foam blank with two pressing surfaces of similar compressive strength of about 44 psi measuring approximately 355 mm by 241 mm by 50 mm. Example 2 is prepared by cutting a foam plank three times (see FIG. 5) to provide two foam blanks 310 and 314 which are laid back to back to form a double-sided foam blank with two pressing surfaces of similar compressive strength of about 34 psi such that the pressing surfaces 312 and 316 are the surfaces provided by the center cut 303 (e.g., 320). Example 2 measures approximately 355 mm by 241 mm by 50 mm. Example 3 is prepared by the same method as Example 2 with the exception that the two foam blanks are adhesively bonded together by the application of a layer consisting of 15 grams of MOR-AD M-652 moisture cure, a one-part urethane adhesive, misted with 3 grams of distilled water, pressed together in a press under 1000 psi and allowed to cure a minimum of one hour before shaping (e.g., 340). Example 3 measures approximately 355 mm by 241 mm by 50 mm.

Comparative Example A, is a foam blank prepared via the conventional method by splitting a 4″ foam plank into two 2 inch foam blanks. Examples 1, 2, and 3 are prepared according to the method of the present invention. Each double-sided foam blank is pressed by an aluminum compression fixture (referred to as a tool or a mold) with a pressing surface milled in the shape of a simple corrugation. The double-side foam blank having a first and a second pressing surface is inserted into a Carver hydraulic press having a first corrugation shaped forming tool on the stationary platen and a second corrugation shaped forming tool movable platen. The Carver press is programmed for a pump speed of 100 percent and the foam is compressed 0.375 inches on each pressing surface, in other words, the movable platen stroke is 0.75 inches. For Comparative Example A, the planed surface is placed against the mold surface on the stationary platen and the cut surface is pressed by the mold on the movable platen. The movable platen moves toward the stationary platen pressing the double-sided foam blank between the first and second corrugated forming tools providing a double-sided shaped foam article (FIGS. 6 to 8). Both tools are kept at ambient temperature and pressed into the foam until a set of stop blocks on the stationary platen contact the moving platen. The platens are then opened and the double-sided shaped foam article is removed from the corrugation tools. No hold or dwell time is used in the forming of the article. During the pressing, each tool is pressed into the foam sufficient distance to fully imbed the pressing tool into the foam resulting in about 35 to about 40 percent maximum applied strain.

The step change 32 or maximum groove depth of compression for each sample is measured 24 hours after forming. Measurements are taken on the stationary platen shaped side and the moving platen shaped side. The depths are measured in inches with a Depth Gauge Micrometer and are an average of five measurements. The values are summarized in Table 1.

TABLE 1

| | | Stationary Platen | Movable platen |
|---|---|---|---|
| Comparative | | Side Maximum | side Maximum |
| Example | Example | Groove Depth, in | Groove Depth, in |
| A | | .27 | .32 |
| | 1 | .29 | .29 |
| | 2 | .30 | .31 |
| | 3 | .30 | .30 |

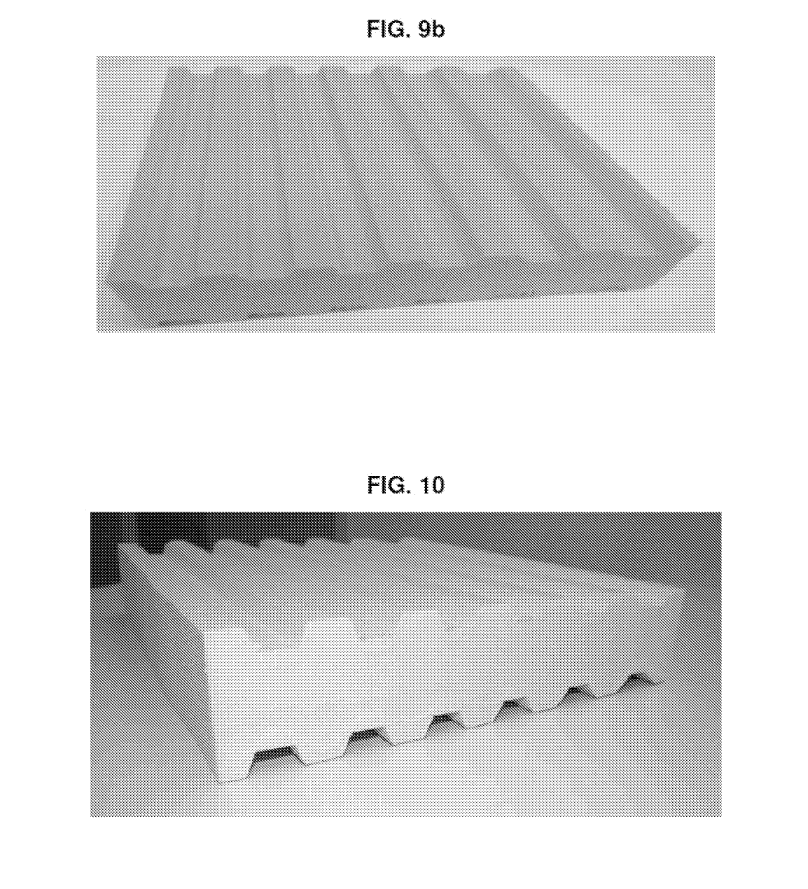

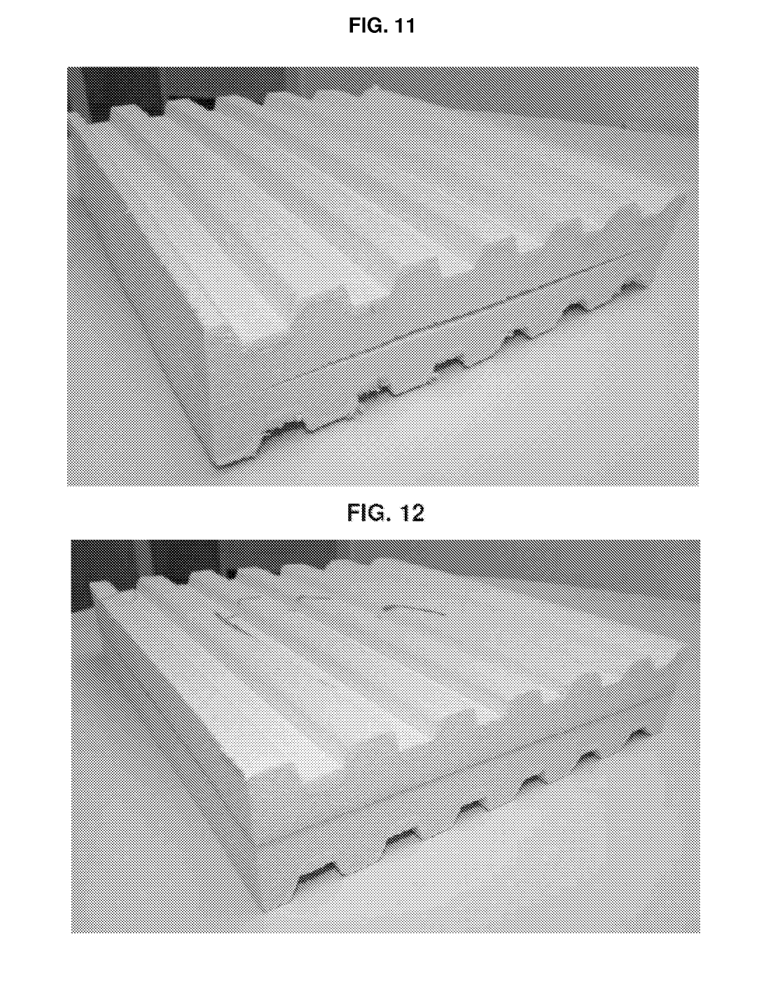

Photographs of the shaped foam articles of Comparative Example A FIGS. 9a and 9B and Examples 1 to 3 are shown in FIG. 10 to FIG. 12.

1. A method to manufacture one or more double-sided shaped foam article comprising the steps of:
(i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has a vertical compressive balance equal to or greater than 0.4,
(ii) cutting the foam plank to form a double-sided foam blank having a first pressing surface with a compressive strength and a second pressing surface with a compressive strength,
(iii) shaping the two pressing surface of the double-sided foam blank into one or more double-sided shaped foam article and surrounding continuous unshaped foam blank by
(ii)(a) contacting each pressing surface of the double-sided foam blank with a mold, said mold comprises one or a plurality of cavities each cavity having a perimeter defining the shape of the shaped foam article and a cavity surface and
(ii)(b) pressing the double-sided foam blank with the mold at an applied strain whereby forming one or more double-sided shaped foam article.

2. The method of claim 1 wherein the difference in compressive strength between the first pressing surface and second pressing surfaces is equal to or less than 200 percent.

3. The method of claim 1 wherein the compressive strength of the first pressing surface is equal to or less than 10 percent.

4. The method of claim 1 wherein the foam has a cell gas pressure equal to or less than 1 atmosphere.

5. The method of claim 1 wherein the thermoplastic polymer is polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyethylene terephthalate; polyvinyl chloride; polyphenylene oxide and polystyrene blend.

6. The method of claim 1 wherein the blowing agent is a chemical blowing agent, an inorganic gas, an organic blowing agent, carbon dioxide, water, or combinations thereof.

7. The method of claim 1 wherein the maximum applied strain is equal to or less than 80 percent.

8. A double-sided shaped foam article made by the method of claim 1.

9. The double-sided shaped foam article of claim 8 is a raised door panel, a garage door panel, packaging material, an insulated window frames, an energy absorbing countermeasure for occupant injury mitigation, a lost core foam molding, a decorative coving, a decorative cornice, an exterior insulation facade panel, an architectural panel, a furniture article, or a foam core insert for various panels.
